(19) United States
(12) Patent Application Publication
(10) Pub. No.: US 2014/0291232 A1
(43) Pub. Date: Oct. 2, 2014

(54) Foot Pump Water Filtration System

(71) Applicant: Tareq Adel Risheq, Newport Beach, CA (US)

(72) Inventor: Tareq Adel Risheq, Newport Beach, CA (US)

(21) Appl. No.: 14/226,733

(22) Filed: Mar. 26, 2014

Related U.S. Application Data
(60) Provisional application No. 61/805,216, filed on Mar. 26, 2013.

(51) Int. Cl. B01D 29/90; B01D 29/56

(52) U.S. Cl. CPC B01D 29/90; B01D 29/56
USPC 210/335; 210/416.3

(57) ABSTRACT

A portable water treatment device that utilizes a foot-powered actuator to impel water through a filter is disclosed. The actuator moves to generate negative pressure that draws water to be treated into the interior of a housing, then moves to generate positive pressure to impel the water thus drawn in through a filtration device and to impel treated water out of the device. In some embodiments the water treatment device includes two actuators that are coupled to move in tandem.

This application claims priority to U.S. Provisional Patent Application No. 61/805216 filed on Mar. 26, 2013. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is water delivery systems, in particular water delivery systems with filters and human-powered pumps.

### BACKGROUND

Clean, potable water is an essential component for life. Unfortunately natural or raw water sources are increasingly affected by pollution and biological contamination, making them unsafe to consume without proper treatment. In industrialized nations this need is usually met by municipal water processing plants, which treat water prior to distribution through the municipal infrastructure. Such facilities, however, are not always available in developing economies or to individuals who are engaged in work or recreation away from developed areas.

Treatment of potentially contaminated water with chemical additives, such as sodium dichloroisocyanurate or tetraglycine hydroperiodide tablets, is a known method for disinfection in the field. Unfortunately, such disinfectants can be slow to act and can affect the taste of the treated water. In addition, such chemical treatment may not be completely effective against contaminating microorganisms, notably Cryptosporidium and Giardia. Also, by their nature such chemical additives do little to address the problem of chemical pollution.

Another water treatment option is filtration. Filtration methods can utilize chemical filtration (for example treatment with adsorbents such as activated carbon), particulate filtration (for example treatment by passage through a pleated or wound filter material), and/or reverse osmosis or ultrafiltration (for example treatment by passage through a semi-permeable membrane). These are often used in combination. For example, a typical consumer reverse osmosis water treatment unit typically includes a particle filter, a carbon filter, and a reverse osmosis/ultrafiltration membrane. Filtration, however, necessarily requires a source of power or pressure to drive the water being treated through the filtration materials. In a typical industrial or household water treatment installation this can be supplied by pressure from the municipal water main, often supplemented by a pump. Such power and/or pressure sources are not likely to be found in the field, and may be lacking or inconsistent in developing economies.

Portable water treatment systems with pumps and filters are generally known in the art. However, most designs utilize hand-pumps, which requires the user to use one hand to grasp the housing and the other hand to actuate (e.g., push and pull) the pump. Unfortunately, passage of water through a filter necessarily entails resistance. This resistance can be considerable when the pores or openings of a filter material through which the water must pass are small, for example the pores of filters intended to remove microorganisms and the pores of filter membranes used in ultrafiltration. This limits the use of such hand-powered devices for extended periods of time and restricts their utility for persons with limited upper body strength. As such they are only practical for processing only small volumes of water.

Some designs for foot-driven pumps and filters have been described in the art. For example, U.S. Pat. No. 5,685,980 (to Patapoff and Wong) discloses a portable system with two physically coupled reservoirs (for raw and treated water), a particle filter, and a reverse osmosis filter, with pressure being supplied by a simple piston pump. The possibility of using a foot-powered pump to introduce air into the device is briefly noted, however no indication of how this could be implemented is provided. United States Patent Application No. 2006/0,151,393 (to Badger) discloses a device that forces raw or brackish water adsorbent (i.e. carbon), reverse osmosis, and anti-microbial media and into a treated water reservoir using an inflatable bladder as a pressure source. This inflatable bladder can be pressurized using a separate foot pump. United States Patent Application No. 2007/0,199,875 (to Moorey and Moorey) discloses a filtration device that suspends a number of particle filters over a container, where the filtered water is collected for batch chemical treatment and storage. The device utilizes two pumps. The first pump, which is engine-powered, provides raw water to the particle filters. The second pump, which can be foot-powered, is used for distributing filtered and treated water. United States Patent Application No. 2011/0,198,275 (to Hayes) discloses a closed, pressurized system that can utilize a foot-powered pump to pressurize a water containing reservoir. The pressure forces a portion of the water through the membrane of a reverse osmosis filter, with the remainder of the water being transferred to a secondary, non-pressurized tank for reprocessing. Unfortunately. these systems are large, heavy, and complex, with limited portability.

These references and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for portable water delivery systems that provide filtration and can be operated using human-provided power.

### SUMMARY OF THE INVENTION

The present invention provides a liquid delivery system for filtering and dispensing a liquid. The delivery system comprises an enclosure (e.g., housing) that has walls. The walls of the enclosure define a reservoir for containing the liquid (e.g., water). The enclosure has an inlet for drawing liquid into the reservoir and an outlet for dispensing the liquid from the reservoir. Within the reservoir is a filter for filtering constituents (e.g., contaminants, bacterial, virus, particles, etc) from the liquid before dispensing. The enclosure has an actuator (e.g., foot pump) for creating pressure changes within the reservoir so that the liquid can be drawn into and dispensed from the reservoir.

The actuator comprises a structure movably coupled with a wall of the enclosure and movable between two states (e.g., positions).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts an external view of a water treatment device of the inventive concept.

FIG. 2 depicts a view of a water treatment device of the inventive concept in which a portion of the housing has been rendered transparent.

FIG. 3 depicts a section through a water treatment device of the inventive concept.

FIG. 4 shows an exemplary filter cartridge.

FIG. 5 schematically depicts a cross section of a water treatment device of the inventive concept having two actuators.

### DETAILED DESCRIPTION

A portable, human-powered water filtration system is described that allows the production of potable water from contaminated sources. The filtration system provides a housing with at least one actuator, which moves between two positions and can be operated by applying pressure with the foot. In operation the housing can be placed on the ground with a feed line that leads to a contaminated water source. Movement of the actuator draws contaminated water through the feed line and into the housing. Movement of the actuator can also impel water through a filter (for example, a filter cartridge) and drive the filtered water through a potable water line. The filtration system can include a spring or other device to assist in moving the actuator between positions. In some embodiments the filtration includes two actuators that are coupled, such that movement of one actuator between positions results in the movement of the other actuator between positions.

The following description includes information that may be useful in understanding the present invention. It is not an admission that any of the information provided herein is prior art or relevant to the presently claimed invention, or that any publication specifically or implicitly referenced is prior art.

One should appreciate that the water filtration system disclosed herein permits the convenient production of safe, potable water from contaminated sources using a highly portable device that can be powered for an extended period of time by a single person.

some embodiments, the numbers expressing quantities of ingredients, properties such as volume, flow rate, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Devices and systems of the inventive concept include a housing, which acts (at least in part) as a reservoir for contaminated water prior to treatment. The housing encloses one or more filters or filter cartridges that can remove at least some of the contaminants from the contaminated water. In some embodiments the housing encloses a single reservoir space, with the filter or filter cartridge lying within the reservoir space. In other embodiments the housing encloses a reservoir space that encloses contaminated water and a filtration space that encloses the filter or filter cartridge, with the reservoir space being separated from the filtration space by an internal wall. The filter or filter cartridge is in fluid communication with a potable water line, which leads filtered, potable water out of the system or device. Such a reservoir space can be sized to accommodate between 0.5 liter and 20 liter of water. In other embodiments a reservoir space can be sized to accommodate between 1 liter and 15 liter of water. In still other embodiments a reservoir space can be sized to accommodate 4 liters of water.

The housing also supports an actuator, which provides motive force for bringing contaminated water into the housing and for driving contaminated water through filter. In preferred embodiments the housing is configured to be stable when placed on an approximately level surface, and to have a height that places the actuator at a convenient position for the application of pressure by the foot of a user whose stature is within normal range. In some embodiments the actuator is a solid body. In other embodiments the actuator is a hollow, sealed body. In still other embodiments the actuator is open at one end and can be at least partially fluid filled (i.e. with water, air, or a mixture of water and air).

In use the actuator can be depressed (i.e. at least partially driven into the interior of the housing) through the application of pressure by a human being, preferably by the application of pressure via the foot (for example, by stepping down on the actuator) to move it from a first position (i.e. an extended position) to a second position (i.e. a depressed position). In moving from an extended to a recessed position an actuator can displace a volume between 50 mL and 1.5 liters within the attendant reservoir. In other embodiments, in moving from an extended position to a recessed position an actuator can displace a volume between 100 mL and 1 liter within the attendant reservoir. In still other embodiments, in moving from an extended position to a recessed position an actuator can displace a volume between 200 mL and 750 mL within the attendant reservoir. Systems of the inventive concept can also include devices that assist impelling the actuator back to the extended position. For example, an actuator can be affixed to a spring that engages a portion of the housing and is compressed when the actuator moves to the depressed position. Decompression of the spring following the release of downwards pressure by the user. Alternatively, the actuator can include a fixator (for example a loop, strap, or hook and loop device) that at least temporarily affixes the actuator to the user's foot, such that moving the foot upwards after stepping down returns the actuator to the extended position. In some embodiments, described in greater detail below, a first actuator can be coupled to a second actuator such that depression of the first actuator impels the second actuator to an extended position and vice versa. Such an arrangement advantageously permits a user to utilize both feet and minimizes fatigue. In some embodiments the housing can be affixed, either permanently or temporarily, to a floor or similar surface, for example using screws, adhesives, hook loop closures, and/or by pressure applied by the user's other foot.

Impelling an actuator into the housing (for example, by stepping down on the actuator) displaces volume within the housing. Since water is essentially non-compressible this action drives contaminated water through the filter or filter cartridge. Similarly, returning the actuator to the extended position results in negative displacement, which can be used to draw additional contaminated water into a reservoir within the housing. Systems of the inventive concept can include one or more valves to direct water flow in order to accomplish this. For example, a system or device of the inventive concept can include a one-way flow valve that is in fluid communication with an internal reservoir for contaminated water and a contaminated water feed line (which is in turn in fluid communication with a source of contaminated water).

Depending upon the configuration of the system, filtered, potable water can be collected from the exterior of a filter/filtration cartridge or can be collected from an interior collection space of the filter/filtration cartridge. For example in a configuration where a filter cartridge lies within a reservoir containing contaminated water, application of pressure (for example, by depression of the actuator) can drive water through the exterior surface of the filter cartridge and through the filter media to an internal (i.e. central) collection space. Similarly, in other embodiments the filter cartridge can be held in a filtration space that is in fluid communication with a reservoir or chamber holding contaminated water. When pressure is applied to the reservoir holding contaminated water, the contaminated water is driven through the exterior surface of the filter cartridge, through the filtration media, and into an internal collection space. In such embodiments the internal collection space can be in fluid communication with a potable water outlet or line. In an alternative configuration where a filter cartridge is held in a space or chamber distinct from that holding contaminated water, application of pressure to the contaminated water chamber can drive contaminated water through an access line in fluid communication with the interior of the cartridge, through the filter media, and through the outer surface of the cartridge into a filtration space. In such embodiments the filtration space can be in fluid communication with a potable water line or outlet. Filtered or potable water can be collected from such a potable water line or outlet at a rate of 10 mL to 1 liter per transition of the actuator from the extended position to the recessed position. In other embodiments, filtered or potable water can be collected from such a potable water line or outlet at a rate of 50 mL to 750 mL per transition of the actuator from the extended position to the recessed position. In still other embodiments, filtered or potable water can be collected from such a potable water line or outlet at a rate of 100 mL to 500 mL per transition of the actuator from the extended position to the recessed position.

The housing can be a unitary body, or can be made in two or more parts, and can at least temporarily accommodate greater than atmospheric pressure. In multi-part embodiments the joint between the portions of the housing can include a gasket or seal. Devices and systems utilizing single-part housings can be disposable. Similarly, devices and systems utilizing multi-part housings can include filtration materials and/or filter cartridges that can be replaced by the user. A housing of the inventive concept can be made of any suitable material, including metal and metal alloys (for example, aluminum, copper, brass, and/or stainless steel), resin, fiberglass, carbon fiber, vulcanized rubber, plastics (for example, polyvinyl chloride, polyethylene, polypropylene, polyurethane, and/or polyamide), or a combination of these.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

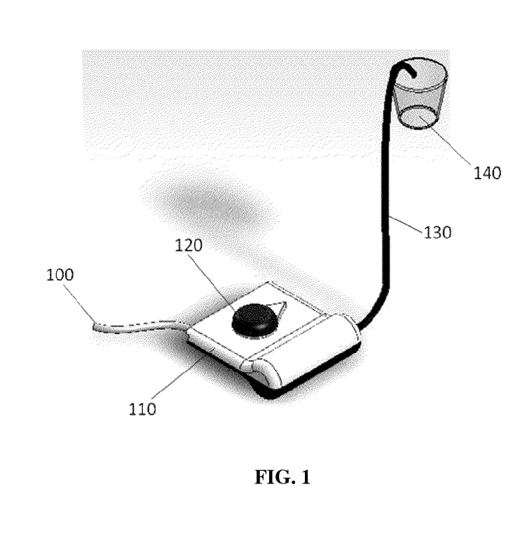

An external view of an embodiment of the inventive concept is shown in FIG. 1. A feed line for contaminated water 100 is in fluid communication with a housing 110. The housing 110 encloses an interior space that accommodates a volume of contaminated water and a filter/filter cartridge. The housing 110 also supports an actuator, which is positioned and dimensioned to be easily depressed by a human foot. As shown, the dimensions and profile of the housing 110 can be selected to provide stability as the actuator is depressed. As described above, depression of the actuator provides a driving force that impels contaminated water through a filter/filter cartridge to produce potable water, which leaves the housing 110 through a potable water line 130. Treated water leaving the potable water line 130 can be ready for consumption 140, or can be set aside for further processing.

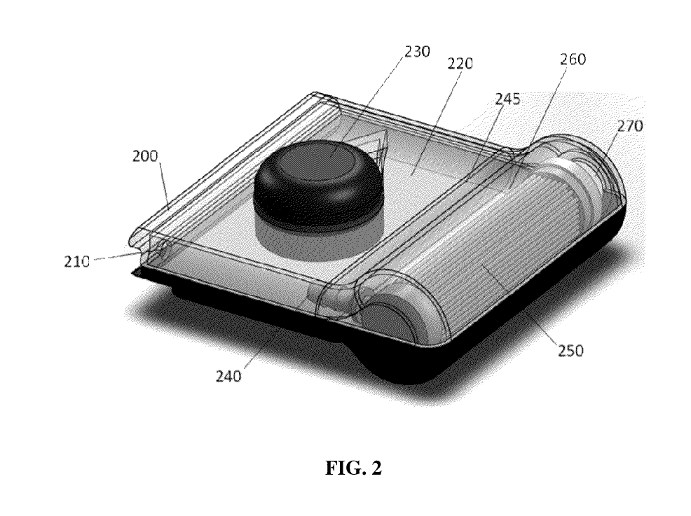

FIG. 2 depicts an embodiment of a device of the inventive concept in which a portion of the housing 200 has been rendered transparent so as to reveal the interior. The housing 200 includes a contaminated water port 210, which can serve as a point of attachment for a contaminated water line feed line (as in 100 of FIG. 1). In some embodiments a valve that controls the direction of water flow (for example, a one way flow valve) can be placed at the contaminated water port 210, such that contaminated water can be drawn into a contaminated water reservoir 220 of the device. The actuator 230 is shown in an extended position, and can be depressed to pressurize the contaminated water reservoir 220. In this embodiment, the housing 200 includes an interior wall 245 that separates the contaminated water reservoir 220 from a filtration space 260 that encloses a filter/filtration cartridge 250. In such an embodiment, contaminated water can enter the filtration cartridge 250 when the actuator 230 is depressed via a cartridge inlet 240 that protrudes through the interior wall 245 and into the contaminated water reservoir 220. After passing through the media of the filtration cartridge 250 treated, potable water enters the filtration space 260, which includes an interface 270 that places the filtration space 260 in fluid communication with a potable water line (as in 130 of FIG. 1). Upon returning to the extended position, the actuator 230 generates negative pressure that draws additional contaminated water through the contaminated water port 210 and into the contaminated water reservoir 220.

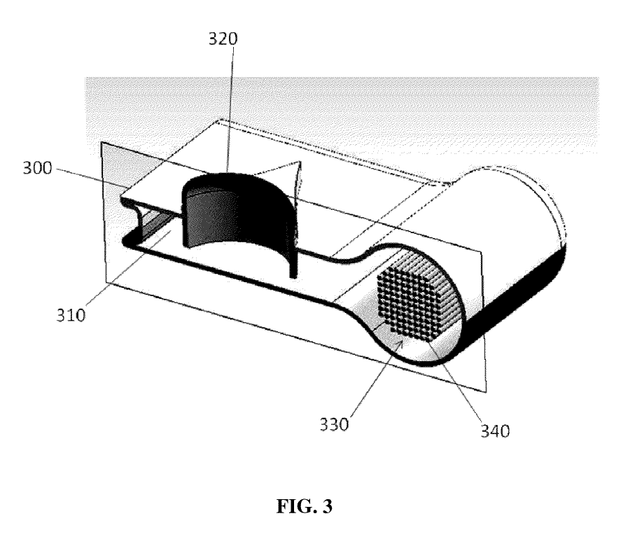

FIG. 3 depicts a cross section through another embodiment of the inventive concept. In such an embodiment the housing 300 includes an interior space 310 that, in use, encloses both contaminated water and a filter/filter cartridge 330. In this instance the filter cartridge 330 is comprised of a bundle of individual filter fibers 340, a configuration that increases the surface area of the filter and improves resistance to fouling. In this figure the actuator 320 is shown in depressed or partially depressed position, and is open within the interior of the housing. In such an embodiment, pressurization of the housing 300 by depression of the actuator 320 impels contaminated water through the exterior surface of the filter cartridge 330 and through the filter media or filter membrane of the filter fibers 340. The treated, potable water is collected from the interior of these, which are in fluid communication with an outlet for potable water.

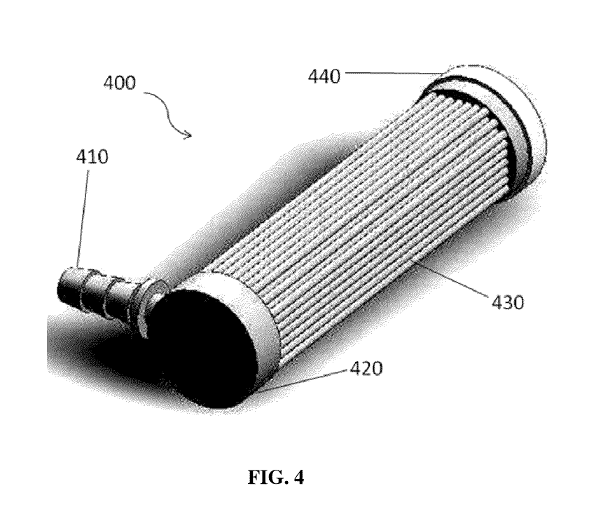

A typical filter/filter cartridge of the inventive concept is shown in FIG. 4. Such a filter cartridge 400 can include a filter connection 410 that is in fluid communication with a first end cap, a filter surface 430 (which can be the collective surfaces of individual filter fibers) and a second end cap 440. In some embodiments the first end cap 420 is in fluid communication with the interior of the filter or, alternatively, is in fluid communication with the interior of individual filter fibers. It should be appreciated that in some embodiments contaminated water can be introduced through the filter connection 410, such that treated, potable water is collected after passing through filter media/membrane at the filter surface 430. In alternative embodiments, contaminated water is impelled through the filter surface 430, passes through the filter media/membrane, and is collected from the filter interior at the filter connection 410.

It should further be appreciated that systems and devices of the inventive concept can support or utilize a variety of filter types. For example, a filter/filter cartridge can be a particle filter, such as a pleated filter or a wound fabric filter, which can remove particles of approximately 20 μm or larger in diameter. Alternatively, filter/filter cartridge can be a microparticle filter (for example, a micropore filter or a ceramic filter), which can remove particles of approximately 0.2 μm or larger. In other embodiments, a filter/filter cartridge can be a reverse osmosis or ultrafilter, which excludes molecules greater than about 15-20 nm in size and essentially permits only the passage of water. Such reverse osmosis filters can be supplied as a wound sheet of membrane filter, or as a collection of individual hollow filter fibers. In still other embodiments, the filter/filter cartridge can include a material that exchanges and/or adsorbs contaminating compounds from the water being treated, such as an ion exchange resin, and adsorbing hydrophobic polymer, and/or a highly porous material such as activated carbon. In such an embodiment, the filter/filter cartridge can be a permeable container or bag for enclosing such exchanging and/or adsorbing media; in other such embodiments the filter/filter cartridge can include such exchanging and/or adsorbing media as a structural component (such as a carbon block). Such a structural component or block could be molded into any shape suitable for efficiently filtering the liquid (e.g., cylindrical, cone, frustoconical, etc.) It should be appreciated that a filter/filter cartridge of the inventive concept can include two or more of these filter modes or methods, which can be arranged sequentially to prolong filter life (for example, from large particle size exclusion to small particle size exclusion). Similarly, a filter/filter cartridge of the inventive concept can include additional materials (for example, an antimicrobial substance such as silver metal or iodine containing compounds) that enhance the function of the filtration device without performing a conventional filtration function.

In a preferred embodiment of the inventive concept, the filter/filter cartridge includes a High Reactivity Carbon Mixture (HRCM). HCRM is manufactured by a unique method of cold autocatalytic decomposition of graphite, which results in the formation of a carbon-based nano-material. HRCM has an extremely large specific surface area (2,500 m2/per 1 g HRCM). The surface of this material consists of atomic layers of cyclic carbon (graphenes) with damaged molecular bonds. HRCM is a chemically inert substance, electro conductive, hydrophobic, stable in corrosive environments and ecologically clean. Depending on the manufacturing method, HRCM can consist of 99.4% pure carbon materials with a bulk density of 0.01-0.001 g/cm3. Filter 220 can have a pore size of at least 0.2 to 100 microns, preferably 1 to 25 microns. HRCM can remove particles including but not limited to sulphates, sulphides, fluorides, chlorides, nitrites, iron, zinc, copper, aluminum, manganese, lead, arsenic, molybdenum, and other small particles suspended in water. HRCM is also capable of removing microorganisms, such as bacteria and viruses, and to prevent reproduction of microorganisms HRCM can be coated with particles of silver and iodine.

Referring again to FIG. 1, in operation, a user places a contaminated water feed hose 100 into a source of contaminated water and potable water outlet hose 130 in a position suitable for the delivery of treated, potable water (e.g., container, cup 140, mouth, etc). The user then presses down on actuator 120 with his/her foot into the depressed postion, which forces water out of a reservoir within the housing 110 and through a filter. The user then lifts his/her foot and a returning device (such as a spring) returns the actuator 120 to the extended position, drawing water into a reservoir within the housing 110 via negative pressure. The user can repeatedly step on actuator 120 to deliver additional filtered water.

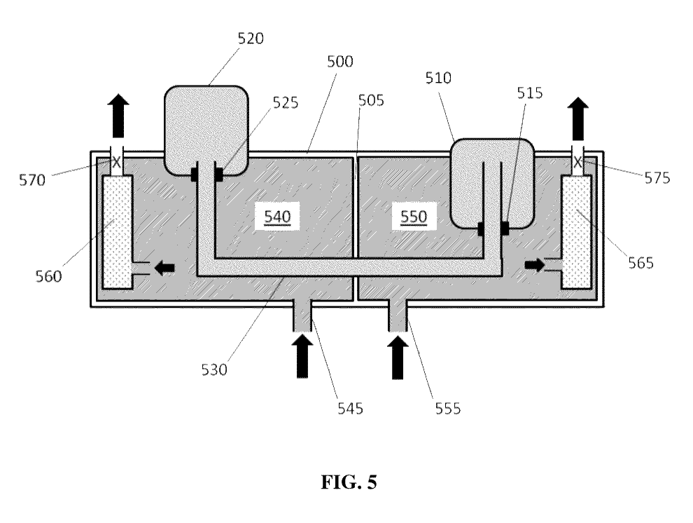

FIG. 5 depicts another embodiment of the inventive concept, which incorporates two actuators that act in tandem. In such an embodiment a housing 500 is divided by an interior wall 505 into two contaminated water reservoirs 540, 550. The system also includes first actuator 510 that is in contact with a first contaminated water reservoir 550 and a second actuator 520 that is in contact with a second contaminated water reservoir 540. The actuators 510, 520 are coupled, such that depression of one actuator (for example, actuator 510) leads to moving the other actuator (for example, actuator 520) to an at least partially extended position. This coupling can be a mechanical coupling, for example a mechanical coupling of the actuators to a common beam with a central fulcrum. In a preferred embodiment, the coupling between the actuators 510, 520 is a fluid coupling, wherein a working fluid (for example, water, air, and/or oil) is transferred from one actuator to the other via a conduit 530, with each actuator moving/sliding along portions of the conduit as the working fluid is transferred from the depressed actuator to the rising actuator. In such an embodiment the actuator may further include a seal 515, 525 (for example, an o-ring, interposed between the actuator and the conduit that retains the working fluid within such a dual actuator assembly. This tandem arrangement advantageously uses part of the force provided by a user to move one actuator to a depressed position to move the other actuator to an extended position, allowing a user to utilize both feet and reduce fatigue. Accordingly, each contaminated water reservoir 540, 550 has a contaminated water inlet (545 and 555, respectively), which can be fitted with a valve to control the direction of water flow (for example, a one-way valve that directs contaminated water into a contaminated water reservoir). Depression of an actuator (510, 520) impels contaminated water within the associated contaminated water reservoir (550 and 540, respectively) through an associated filter/filter cartridge (565 and 560, respectively). Treated water 575, 570 can then be collected from either or both sides for use.

In some embodiments the filter/filter cartridges 560, 565 can utilize different filtration modes and/or utilize different filtration media. In such an embodiment, the filtered water output from one side of such a dual water filtration system can be directed to the water feed line of the other side of the dual water filtration system. For example, in a dual water filtration system as shown in FIG. 5, treated water obtained from contaminated water reservoir 540 could be treated with a filter cartridge 560 that performed a first filtration mode or operation (for example, particle removal), and the resulting filtered water 570 directed to the water inlet 555 to enter the remaining water reservoir 550 to be treated with a second filter cartridge 565 that utilizes a second filtration mode (for example, adsorption of organic pollutants) to produce a final, double-filtered water product 575.

In some embodiments of the inventive concept, the water filtration system can include additional control valves (for example, one-way flow valves) on or in fluid communication with an outlet line for filtered water in order to prevent a backflow of air or water through the filter/filtration cartridge as the actuator moves from the recessed position to the extended position. In some embodiments of the inventive concept such a control valve can be removed, bypassed, or reversed in order to permit backflushing of the filter/filter cartridge in order to dislodge filtered material from the filter/filter cartridge. Such dislodged material can, for example, be removed by draining the contaminated water reservoir after performing such a backflushing operation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A water delivery system, comprising:
a housing having a first inlet, a first outlet, and a plurality of walls that define a first reservoir, wherein the first inlet and first outlet are disposed on a wall of the enclosure;
a first filter that is in fluid communication with the first reservoir and in fluid communication with the first outlet, such that the filter is interposed between the first reservoir and the first outlet; and
an actuator movably coupled with a wall of the enclosure, and movable between an extended position and a recessed position, wherein movement between the extended position and the recessed position displaces fluid within the first reservoir.

2. The water delivery system of claim 1, further comprising a first inlet house coupled to the first inlet.

3. The water delivery system of claim 1 further comprising a first outlet house coupled to the first outlet.

4. The water delivery system of claim 1, further comprising:
a second reservoir, the second reservoir being in fluid communication with a second inlet of the housing;
a second filter that is in fluid communication with the second reservoir and in fluid communication with a second outlet of the housing, such that the second filter is interposed between the second reservoir and the second outlet; and
a second actuator movably coupled with a wall of the enclosure, and movable between an extended position and a recessed position, wherein movement between the extended position and the recessed position displaces fluid within the second reservoir.

5. The water delivery system of claim 4, wherein the first actuator and the second actuator are coupled, such that movement of the first actuator from the extended position to the recessed position induces movement in the second actuator from the recessed position to the extended position.

6. The water delivery system of claim 5, wherein the first actuator and the second actuator are fluidly coupled via a conduit, and wherein the first actuator and the second actuator are slidably engaged with the conduit.

7. The water delivery system of claim 4, wherein the first filter utilizes a first filter mode and the second filter utilizes a second filter mode.

8. The water delivery system of claim 7, wherein the first outlet is fluidically coupled to the second inlet, such that water entering through the first inlet passes through both the first filter and the second filter before exiting through the second outlet.
